(19) United States
(12) Patent Application Publication
(10) Pub. No.: US 2026/0054335 A1
(43) Pub. Date: Feb. 26, 2026

(54) COMPOSITE GRINDING MACHINE

(71) Applicant: JTEKT CORPORATION, Kariya-shi (JP)

(72) Inventors: Makoto TANO, Obu-shi (JP); Takaya NAGAHAMA, Obu-shi (JP); Keisuke USUDA, Nagoya-shi (JP); Koichi SHIIBA, Nisshin-shi (JP); Kohei KATO, Nagoya-shi (JP); Masato ITO, Kariya-shi (JP)

(73) Assignee: JTEKT CORPORATION, Kariya-shi (JP)

(21) Appl. No.: 18/685,376

(22) PCT Filed: Sep. 6, 2021
(86) PCT No.: PCT/JP2021/032635

§ 371 Date: Apr. 23, 2025

(51) Int. Cl. B23P 23/04; B23K 26/342; B24B 5/04; B24B 49/12; B24B 55/02; B24B 55/04; B33Y 30/00; B33Y 40/00; B33Y 50/00

(52) U.S. Cl. CPC B23P 23/04; B23K 26/342; B24B 5/04; B24B 49/12; B24B 55/02; B24B 55/04; B33Y 30/00; B33Y 40/00; B33Y 50/00

(57) ABSTRACT

To reduce, in processing in which grinding is performed after additive manufacturing, an amount of coating formed by additive manufacturing that exceeds a thickness required for a product. A composite grinding machine includes a holding unit that is configured to hold and rotate a workpiece, an additive manufacturing unit that is configured to move with respect to the holding unit, and that fuses a material while supplying the material to a surface of the workpiece that is held by the holding unit, thereby causing adhesion of the material to the surface, a grinding unit that is configured to move with respect to the holding unit and that includes a grindstone and rotates the grindstone, and a coolant supply unit that supplies a coolant to a portion where the workpiece held by the holding unit and the grindstone come into contact.

### TECHNICAL FIELD

The present disclosure relates to a composite grinding machine.

### BACKGROUND ART

In technology according to Patent Document 1, a cylindrical base material is subjected to overlay processing by laser metal deposition (LMD), and an overlaid portion that is formed is ground. As a result, a hard metal coating made up of tungsten carbide or chromium is formed on a surface of the cylindrical base material.

In the technique according to Patent Document 1, the following processing is executed in order. The cylindrical base material is attached to a device that executes LMD. LMD is executed on the base material, while rotating the cylindrical base material. The cylindrical base material is removed from the device that executes LMD. The cylindrical base material is attached to a grinding machine. The grinding machine performs grinding on a surface of the overlaid portion of the cylindrical base material while rotating the base material.

### RELATED ART DOCUMENTS

### Patent Documents

Patent Document 1: Japanese Unexamined Patent Application Publication No. 2017-110239 (JP 2017-110239 A)

### SUMMARY OF THE INVENTION

### Problem to be Solved by the Invention

When the cylindrical base material is attached to each machining device, attaching the base material such that the central axis of the cylindrical base material and the central axis of each machining device for rotating the base material are ideally the same, is virtually impossible. For this reason, the central axis of an outer peripheral face of the cylindrical base material before LMD is performed, the central axis of the outer peripheral face of the cylindrical base material, including the overlaid portion after LMD is performed, and the central axis of the outer peripheral face of the cylindrical base material including the overlaid portion after grinding is performed, are slightly misaligned. In order to ensure that the hard metal coating after grinding has a sufficient thickness even when such a misalignment exists, in the technology of Patent Document 1, the overlaid portion is formed in the LMD to have a thickness larger than that required for a product. That is to say, a so-called machining allowance is provided. In processing in which grinding is performed after additive manufacturing, there is demand for a technology that reduces the amount of the coating formed by additive manufacturing that exceeds the thickness required for the product.

### Means for Solving the Problem

The present disclosure can be implemented as the following aspects.
(1) According to an aspect of the present disclosure, a composite grinding machine is provided. The composite grinding machine includes a holding unit that is configured to hold and rotate a workpiece, an additive manufacturing unit that is configured to move with respect to the holding unit, and that fuses a material while supplying the material to a surface of the workpiece that is held by the holding unit, thereby causing adhesion of the material to the surface, a grinding unit that is configured to move with respect to the holding unit, and that includes a grindstone and rotates the grindstone, and a coolant supply unit that supplies a coolant to a portion where the workpiece held by the holding unit and the grindstone come into contact.

According to such an aspect, formation a layer of material on the surface of the workpiece, and grinding the layer, can be performed without removing and reattaching the workpiece. Thus, misalignment in position among a plurality of times of attachment of the workpiece does not affect precision of the shape and the dimensions of the layer of the material formed on the surface of the workpiece. Accordingly, in comparison with a form in which the formation of the layer of material on the surface of the workpiece and the grinding of that layer are performed using different devices, the thickness of the layer of material formed on the surface of the workpiece beyond that which is necessary for a product can be reduced.
(2) In the composite grinding machine of the above aspect, an aspect may be made in which the additive manufacturing unit includes optical equipment used for adhesion of the material to the surface, and the composite grinding machine further includes a protective unit that prevents the coolant from adhering to the optical equipment.

According to such an aspect, in the composite grinding machine including the grinding unit and the additive manufacturing unit, the likelihood of coolant scattered by the grindstone that rotates and the workpiece that rotates adhering to the optical equipment, thereby deteriorating the precision of adhesion of the material to the surface by the additive manufacturing unit, can be reduced.
(3) In the composite grinding machine of the above aspect, an aspect may be made in which the protective unit includes a cover that has an opening and a lid portion configured to open and close the opening, and that covers the optical equipment, and the protective unit is configured to selectively place the lid portion in an open position in which the lid portion opens the opening, and the optical equipment takes in light or emits light through the opening when the additive manufacturing unit causes adhesion of the material on the surface, and in a closed position in which the lid portion closes the opening.

According to such an aspect, even when droplets of coolant scattered by the grindstone that rotates and the workpiece that rotates fly toward the optical equipment, the droplets will adhere to the cover covering the optical equipment, since the lid portion is closed. Thus, the likelihood of the coolant adhering to the optical equipment can be reduced.
(4) In the composite grinding machine of the above aspect, an aspect may be made in which the protective unit further includes a pressurization unit configured to increase pressure of space within the cover that accommodates the optical equipment.

According to such an aspect, the likelihood that minute droplets of the coolant will intrude into the space within the cover through a gap around the lid portion and become adhered to the optical equipment can be reduced, even when there are minute droplets of the coolant floating about the composite grinding machine.
(5) In the composite grinding machine of the above aspect, an aspect may be made in which the protective unit is configured to selectively place the optical equipment in a first equipment layout in which the optical equipment is situated when the additive manufacturing unit causes adhesion of the material to the surface, and in a second equipment layout in which the optical equipment is situated when the workpiece held by the holding unit is being ground by the grindstone, and in which the optical equipment is situated, with respect to a component that is not the optical equipment out of components of the composite grinding machine, on a side opposite from the portion where the workpiece and the grindstone come into contact.

According to such an aspect, even when droplets of coolant scattered by the grindstone that rotates and the workpiece that rotates fly toward the optical equipment, the droplets will be adhere to, out of the components of the composite grinding machine, components that are not the optical equipment. Thus, the likelihood of the coolant adhering to the optical equipment can be reduced.
(6) In the composite grinding machine of the above aspect, an aspect may be made in which the protective unit is an air curtain configured to create an air flow between the portion where the workpiece and the grindstone come into contact, and the optical equipment.

According to such an aspect, the likelihood of coolant adhering to the optical equipment can be reduced without disposing any structure between the portion where the workpiece and the grindstone come into contact, and the optical equipment. Accordingly, the degree of freedom in layout of components, such as optical equipment, can be improved for when causing adhesion of the material to the surface of the workpiece.
(7) In the composite grinding machine of the above aspect, an aspect may be made in which the protective unit is provided on a surface of the optical equipment and is of a structure that repels the coolant.

According to such an aspect, the likelihood of coolant adhering to the optical equipment can be reduced without adding a large-scale configuration to the composite grinding machine. Accordingly, the degree of freedom in the layout of components such as the grindstone and so forth during grinding, and the degree of freedom in the layout of the additive manufacturing unit for when causing adhesion of the material to the surface, can be improved.
(8) In the composite grinding machine of the above aspect, an aspect may be made in which the additive manufacturing unit includes, as the optical equipment, a beam emitting unit that emits a light beam that fuses the material, and the composite grinding machine further includes a control unit that controls the composite grinding machine, and that controls the beam emitting unit to emit the light beam to the coolant adhered to the workpiece prior to causing adhesion of the material to the surface, such that at least part of the coolant adhered to the workpiece evaporates.

According to such an aspect, the coolant adhering to the workpiece can be evaporated prior to adhesion of the material to the surface by the additive manufacturing unit. Accordingly, the likelihood that precision of adhesion of the material to the surface by the additive manufacturing unit will deteriorate, due to the coolant adhering to the workpiece, can be reduced.
(9) In the composite grinding machine of the above aspect, an aspect may be made in which the additive manufacturing unit includes, as the optical equipment, a beam emitting unit that emits a light beam that fuses the material, and the composite grinding machine further includes a detection unit that is configured to detect the coolant adhered to the surface, and a control unit that controls output of the light beam for when causing adhesion of the material to the surface, based on a detection result by the detection unit.

According to such an aspect, when coolant remains on the surface produced by the additive manufacturing unit, the output of the light beam can be increased, taking into account the effects of the coolant. Accordingly, the likelihood that precision of adhesion of the material to the surface by the additive manufacturing unit will deteriorate, due to the coolant adhering to the workpiece, can be reduced.

The present disclosure can be implemented in a variety of forms other than the composite grinding machine. For example, the present disclosure can be implemented in forms such as a machining device, a method of manufacturing the machining device, a method of controlling the machining device, a computer program that implements the control method, a non-transitory storage medium that stores the computer program, and so forth.

### BRIEF DESCRIPTION OF THE DRAWINGS

FIG. 1 is an explanatory diagram illustrating a composite grinding machine 1 according to a first embodiment.

FIG. 2 is a diagram illustrating a configuration of part of an additive manufacturing unit 300 in detail.

FIG. 3 is an explanatory diagram illustrating a configuration and operation of a protective unit 500 and the additive manufacturing unit 300.

FIG. 4 is an explanatory diagram illustrating a state of the protective unit 500 and the additive manufacturing unit 300 at a time of a workpiece WP being ground by a grinding wheel 21 of a grinding unit 200.

FIG. 5 is an explanatory diagram illustrating a state of the protective unit 500 and the additive manufacturing unit 300 at a time of the additive manufacturing unit 300 causing adhesion of a material Mx to a surface Sw of the workpiece WP.

FIG. 6 is a flowchart showing processing of machining the workpiece WP.

FIG. 7 is a flowchart showing conventional processing of machining the workpiece WP.

FIG. 8 is an explanatory diagram illustrating a layout of a grinding unit 202, an additive manufacturing unit 302, and a protective unit 502.

FIG. 9 is an explanatory diagram illustrating a state of the protective unit 502 and the additive manufacturing unit 302 at a time of the workpiece WP being ground by the grinding wheel 21 of the grinding unit 202.

FIG. 10 is an explanatory diagram illustrating a state of the protective unit 502 and the additive manufacturing unit 302 at a time of the additive manufacturing unit 302 causing adhesion of the material Mx to the surface Sw of the workpiece WP.

FIG. 11 is an explanatory diagram illustrating a layout of a grinding unit 203, an additive manufacturing unit 303, and a protective unit 503.

FIG. 12 is an explanatory diagram illustrating a state of the protective unit 503 and the additive manufacturing unit 303 at a time of the workpiece WP being ground by the grinding wheel 21 of the grinding unit 203.

FIG. 13 is an explanatory diagram illustrating a state of the protective unit 503 and the additive manufacturing unit 303 at a time of the additive manufacturing unit 303 causing adhesion of the material Mx to the surface Sw of the workpiece WP.

### MODES FOR CARRYING OUT THE INVENTION

### A. First Embodiment

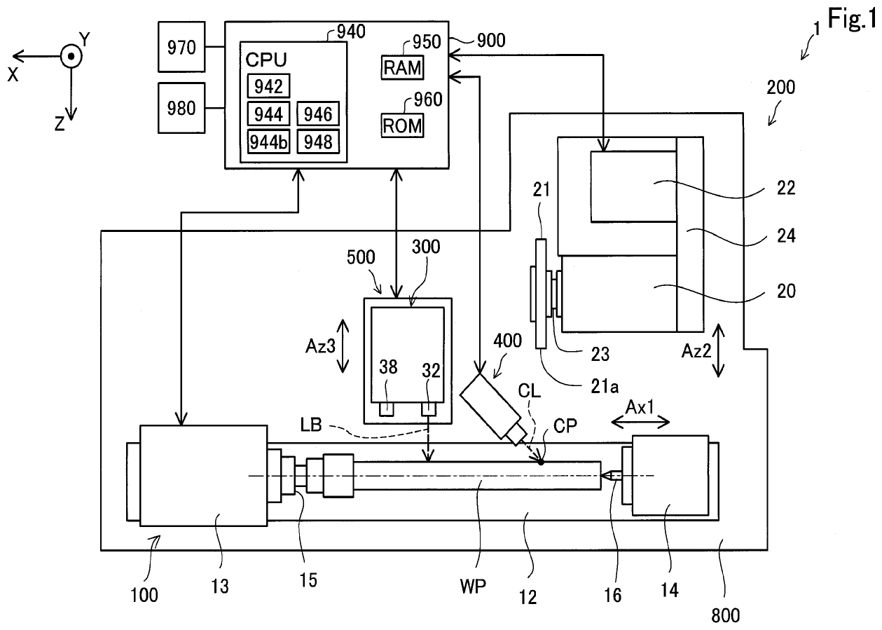

FIG. 1 is an explanatory diagram illustrating a composite grinding machine 1 according to a first embodiment. FIG. 1 corresponds to a plan view. Note, however, that FIG. 1 does not accurately represent the dimensions and shapes of the configurations of each of the parts. Also, in FIG. 1, part of the configurations of the composite grinding machine 1 are omitted from illustration, in order to facilitate understanding of the technology.

The composite grinding machine 1 can perform additive manufacturing (AM), and grinding that is removal machining, on a workpiece WP that is cylindrical. The composite grinding machine 1 includes a holding unit 100, a grinding unit 200, an additive manufacturing unit 300, a coolant supply unit 400, a protective unit 500, a detection unit 38, a bed 800, and a control unit 900.

The holding unit 100 can hold and rotate the workpiece WP (see lower part of FIG. 1). The holding unit 100 is provided so as to be movable in a horizontal direction with respect to the bed 800. The holding unit 100 includes a table 12, a headstock 13, and a tailstock 14.

The table 12 is provided on the bed 800. The table 12 is provided so as to be movable in the horizontal direction with respect to the bed 800. In the present specification, a direction in which the table 12 moves is referred to as an X-axial direction. In FIG. 1, movement of the holding unit 100 is indicated by an arrow Ax1 (see lower right part of FIG. 1).

The headstock 13 is provided on the table 12. The headstock 13 includes a chuck 15. The chuck 15 holds one end of the workpiece WP that is cylindrical. The headstock 13 can rotate the chuck 15.

The tailstock 14 is provided on the table 12. The tailstock 14 includes a center 16. The center 16 holds the other end of the workpiece WP that is cylindrical. The workpiece WP is rotated by the headstock 13 about a rotational axis that is parallel to the X-axial direction, with both ends of the workpiece WP held by the chuck 15 of the headstock 13 and the center 16 of the tailstock 14. The rotational axis of the headstock 13 is indicated by a long dashed short dashed line that is parallel to the X-axial direction in FIG. 1 and FIG. 3 to FIG. 5.

The grinding unit 200 has a function of grinding a surface of the workpiece WP (see middle right part of FIG. 1). The grinding unit 200 includes a wheel spindle stock 20, a grinding wheel 21, a grindstone drive motor 22, a grindstone spindle 23, and a belt transmission mechanism 24.

The wheel spindle stock 20 is provided on the bed 800. The wheel spindle stock 20 is provided so as to be movable in the horizontal direction with respect to the bed 800. A direction in which the wheel spindle stock 20 moves is perpendicular to the direction in which the table 12 moves. In the present specification, the direction in which the wheel spindle stock 20 moves is referred to as a Z-axial direction. In FIG. 1, movement of the grinding unit 200 is indicated by an arrow Az2 (see middle right part of FIG. 1). Also, in the present specification, a vertically upper side is defined as a Y-axial positive direction. An orthogonal coordinate system defined by an X-axis, a Y-axis, and a Z-axis is illustrated in FIG. 1.

The grindstone spindle 23 is supported by the wheel spindle stock 20 so as to be rotatable about a direction that is parallel to the X-axial direction. The grinding wheel 21 is a disc-shaped grindstone. The grinding wheel 21 is connected to the grindstone spindle 23 such that the central axis of the disc and the central axis of the grindstone spindle 23 coincide with each other. A cylindrical grinding face 21a that is parallel to the X-axial direction is provided on an outer peripheral face of the disc of the grinding wheel 21.

The grindstone drive motor 22 is supplied with electric power to output rotational output. The grindstone drive motor 22 is fixed to the wheel spindle stock 20. The belt transmission mechanism 24 transfers the rotational output of the grindstone drive motor 22 to the grindstone spindle 23. That is to say, the grinding unit 200 rotates the grinding wheel 21 by the grindstone drive motor 22, via the belt transmission mechanism 24.

A surface Sw of the workpiece WP that is cylindrical is ground by the grinding unit 200 pressing the cylindrical grinding face 21a of the grinding wheel 21 that is rotating, against the surface Sw of the workpiece WP, while the holding unit 100 is rotating the workpiece WP.

The grinding unit 200 is movable in the Z-axial direction with respect to the holding unit 100, by the wheel spindle stock 20 (see Az2 in middle right part of FIG. 1). Meanwhile, the holding unit 100 is movable in the X-axial direction while rotating the workpiece WP (see Ax1 in lower right part of FIG. 1). Accordingly, traverse grinding as removal machining can be executed on the workpiece WP, held by the holding unit 100, by the grinding unit 200 and the holding unit 100 controlled by the control unit 900.

The coolant supply unit 400 supplies a coolant CL to a portion CP at which the workpiece WP held by the holding unit 100 and the grinding wheel 21 come into contact with each other (see lower right part of FIG. 1). The coolant supply unit 400 is fixed with respect to the grinding unit 200. In FIG. 1, however, the coolant supply unit 400 is illustrated independently of the grinding unit 200, in order to facilitate understanding of the technology. The coolant supply unit 400 includes a tank that stores the coolant CL, and a pump that feeds the coolant CL in the tank to the portion CP at which the workpiece WP and the grinding wheel 21 are in contact with each other.

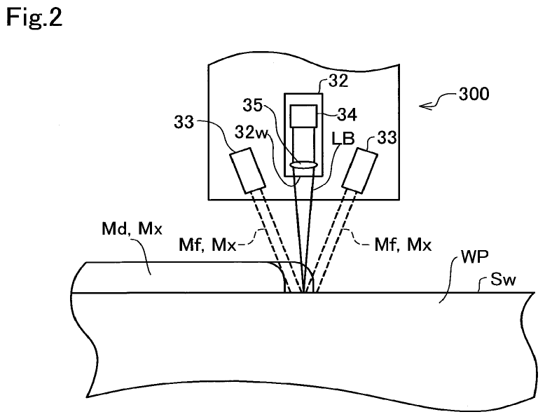

FIG. 2 is a diagram illustrating a configuration of part of the additive manufacturing unit 300 in detail. The additive manufacturing unit 300 has a function of performing additive manufacturing on the surface Sw of the workpiece WP (see the middle part of FIG. 1). The additive manufacturing unit 300 is movable in the Z-axial direction with respect to the holding unit 100. In FIG. 1, movement of the additive manufacturing unit 300 is indicated by an arrow Az3 (see middle left part of FIG. 1). The additive manufacturing unit 300 includes a beam emitting unit 32 and a material supply unit 33.

The beam emitting unit 32 emits a light beam LB to outside of the additive manufacturing unit 300. The beam emitting unit 32 includes an oscillating unit 34 and an optical system 35. The oscillating unit 34 emits a light beam. The optical system 35 converges the light beam emitted by the oscillating unit 34 to a focal point located at a position set in advance with respect to the beam emitting unit 32. In FIG. 2, the optical system 35 is illustrated in the shape of a single convex lens, in order to facilitate understanding of the technology. The beam emitting unit 32 including the optical system 35 is optical equipment that is used to cause adhesion of a material to the surface Sw of the workpiece WP.

The material supply unit 33 supplies powder Mf of cemented carbide to the outside of the additive manufacturing unit 300. The direction of emission of the light beam LB by the beam emitting unit 32 and the direction of emission of the powder Mf of cemented carbide by the material supply unit 33 intersect each other at the focal point of the light beam LB. As a result, the powder Mf of cemented carbide supplied by the material supply unit 33 is fused by the light beam LB. That is to say, the additive manufacturing unit 300 can cause adhesion of the powder Mf of cemented carbide serving as material to the surface Sw of the workpiece WP by fusing the material, while supplying the material to the surface Sw of the workpiece WP held by the holding unit 100. That is to say, the additive manufacturing unit 300 performs directed energy deposition (DED). More specifically, the additive manufacturing unit 300 performs laser metal deposition (LMD).

In the present specification, the material in the powder state is referred to as “powder Mf”. A structure formed by fusing the powder Mf and causing adhesion thereof to the surface Sw of the workpiece WP is referred to as an “additive portion Md” or an “additive layer Md”. The powder Mf, and the material making up the additive layer Md, are collectively referred to as “material Mx”.

An additive portion Md that is annular in shape and is centered on the central axis of the workpiece WP is formed on the surface Sw of the workpiece WP that is cylindrical by the additive manufacturing unit 300 causing adhesion of the material Mx to the surface Sw of the workpiece WP while the holding unit 100 is rotating the workpiece WP.

The additive manufacturing unit 300 is movable in the Z-axial direction with respect to the holding unit 100 (see Az3 in middle left part of FIG. 1). Meanwhile, the holding unit 100 is movable in the X-axial direction while rotating the workpiece WP (see Ax1 in lower right part of FIG. 1). Accordingly, the additive layer Md is formed on the surface Sw of the workpiece WP by adhesion of cemented carbide to the surface Sw of the workpiece WP, which is held and rotated by the holding unit 100, by the additive manufacturing unit 300 and the holding unit 100 controlled by the control unit 900. However, a surface of the additive layer Md is not flat, but has peaks and valleys that are generally parallel to a circumferential direction of the workpiece WP that is cylindrical.

According to such a configuration, formation of the additive layer Md of the material on the surface Sw of the workpiece WP, and grinding of the additive layer Md, can be performed by the composite grinding machine 1, without detaching and reattaching the workpiece WP from and to the composite grinding machine 1. Accordingly, misalignment in the position of the rotational center due to performing attachment of the workpiece WP a plurality of times does not affect the precision of the shape and the dimensions of the additive layer Md of the material that is formed on the surface Sw of the workpiece WP. Thus, a portion that exceeds a thickness necessary for a product, i.e., a so-called machining allowance, can be reduced in the additive layer Md of the material that is formed on the surface Sw of the workpiece WP, in comparison to a form in which different devices are used for forming the additive layer Md of the material on the surface Sw of the workpiece WP, and grinding of the additive layer Md.

The detection unit 38 is an infrared camera (see middle part of FIG. 1). The detection unit 38 is fixed to the additive manufacturing unit 300. The detection unit 38 can acquire the state of the workpiece WP. For example, the detection unit 38 can detect coolant CL adhering to the surface Sw of the workpiece WP. Also, the detection unit 38 can acquire the state of the workpiece WP emitted by the light beam LB. The detection unit 38 is optical equipment used to cause adhesion of the material to the surface Sw of the workpiece WP.

The bed 800 supports the holding unit 100, the grinding unit 200, the additive manufacturing unit 300, the coolant supply unit 400, the protective unit 500, and the detection unit 38. The holding unit 100 is movable in the X-axial direction on the bed 800 (see Ax1 in lower right part of FIG. 1). The additive manufacturing unit 300, and the detection unit 38 that is fixed to the additive manufacturing unit 300, are integrally movable in the Z-axial direction on the bed 800 (see Az3 in FIG. 1). The grinding unit 200, and the coolant supply unit 400 that is fixed to the grinding unit 200, are integrally movable in the Z-axial direction (see Az2 in lower right part of FIG. 1).

The control unit 900 controls the holding unit 100, the grinding unit 200, the additive manufacturing unit 300, the coolant supply unit 400, the protective unit 500, and the detection unit 38. The control unit 900 is a computer that includes a display 970 functioning as an output device, and a keyboard 980 functioning as an input device (see FIG. 1). The control unit 900 further includes a CPU 940 that is a processor, RAM 950, and ROM 960. The CPU 940 causes the holding unit 100, the grinding unit 200, the additive manufacturing unit 300, the coolant supply unit 400, the protective unit 500, and the detection unit 38 to implement various functions which will be described later, by loading a computer program stored in the ROM 960 to the RAM 950, and performing execution thereof.

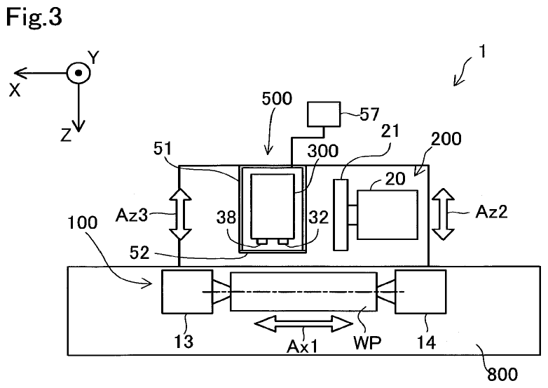

FIG. 3 is an explanatory diagram illustrating the configuration and operation of the protective unit 500 and the additive manufacturing unit 300. FIG. 3 to FIG. 5 correspond to plan views. Note that, however, FIG. 3 to FIG. 5 do not accurately represent the dimensions and the shapes of the configurations of each of the parts. Also, in FIG. 3 to FIG. 5, part of the configurations of the composite grinding machine 1 are omitted from illustration, in order to facilitate understanding of the technology.

The protective unit 500 prevents adhesion of the coolant CL to the beam emitting unit 32 and the detection unit 38 (see upper middle part of FIG. 3). The protective unit 500 includes a cover 51 and a pressurization unit 57.

The cover 51 covers the beam emitting unit 32 and the detection unit 38. The cover 51 has an opening 53 and a lid portion 52. The lid portion 52 is capable of opening and closing the opening 53. The protective unit 500 can selectively dispose the lid portion 52 at an open position Po and a closed position Pc.

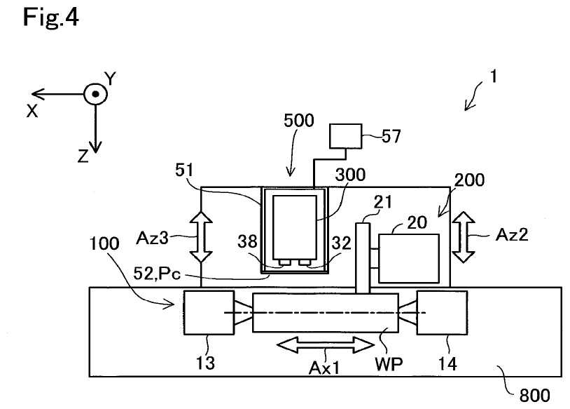

FIG. 4 is an explanatory diagram illustrating a state of the protective unit 500 and the additive manufacturing unit 300 when the workpiece WP that is held by the holding unit 100 is ground by the grinding wheel 21 of the grinding unit 200. When the workpiece WP that is held by the holding unit 100 is ground by the grinding wheel 21 of the grinding unit 200, the grinding unit 200 is moved to a position closer to the rotational axis of the headstock 13 than in the state in FIG. 3 (see Az2 in FIG. 4).

When the workpiece WP that is held by the holding unit 100 is ground by the grinding wheel 21 of the grinding unit 200, the lid portion 52 is disposed at the closed position Pc (see middle part of FIG. 4). In this state, the additive manufacturing unit 300 is located within the cover 51. That is to say, the beam emitting unit 32 and the detection unit 38 are covered by the cover 51. Thus, the beam emitting unit 32 cannot emit the light beam LB to the surface Sw of the workpiece WP. The detection unit 38 cannot acquire the state of the workpiece WP.

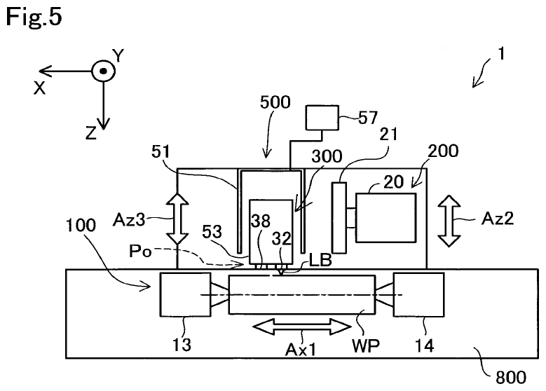

FIG. 5 is an explanatory diagram illustrating a state of the protective unit 500 and the additive manufacturing unit 300 when the additive manufacturing unit 300 causes adhesion of the material Mx to the surface Sw of the workpiece WP. When the additive manufacturing unit 300 causes adhesion of the material Mx to the surface Sw of the workpiece WP, the grinding unit 200 is moved to a position farther from the rotational axis of the headstock 13 than in the state in FIG. 4 (see Az2 in FIG. 5).

When the additive manufacturing unit 300 causes adhesion of the material Mx to the surface Sw of the workpiece WP, the lid portion 52 is disposed at the open position Po (see middle part of FIG. 5). When the lid portion 52 is disposed at the open position Po, the opening 53 of the cover 51 is opened. At this time, the lid portion 52 is moved upward, i.e., in the Y-axial positive direction, from a position at which the lid portion 52 closes the opening of the cover 51 illustrated in FIG. 4. Note that in FIG. 5, the lid portion 52 that is retracted upward is not illustrated. The additive manufacturing unit 300 is moved along the Z-axial direction through the opening of the cover 51, to a position closer to the rotational axis of the headstock 13 than in the state in FIG. 4 (see Az3 in middle left part of FIG. 5). That is to say, the beam emitting unit 32 and the detection unit 38 are not covered by the cover 51.

In this state, the beam emitting unit 32 emits the light beam LB to the surface Sw of the workpiece WP through the opening 53. The material supply unit 33 supplies the powder Mf of cemented carbide to the surface Sw of the workpiece WP through the opening 53. The detection unit 38 takes in light reflected by the workpiece WP through the opening 53. Note that in order to facilitate understanding of the technology, the material supply unit 33 is not illustrated in FIG. 3 to FIG. 5.

According to such a configuration, the likelihood can be reduced that the precision of adhesion of the material Mx to the surface Sw by the additive manufacturing unit 300 will deteriorate, due to the coolant CL that is splashed by the grinding wheel 21 that is rotating and the workpiece WP that is rotating becoming adhered to the beam emitting unit 32 and the detection unit 38 in the composite grinding machine 1 that includes the grinding unit 200 and the additive manufacturing unit 300. Also, the likelihood of the beam emitting unit 32 and the detection unit 38 malfunctioning due to the coolant CL adhering to the beam emitting unit 32 and the detection unit 38 can be reduced.

More specifically, when droplets of the coolant CL, splashed by the grinding wheel 21 that is rotating and the workpiece WP that is rotating, fly toward the beam emitting unit 32 and the detection unit 38, the droplets adhere to the cover 51 covering the beam emitting unit 32 and the detection unit 38 with the lid portion 52 closed. Accordingly, the likelihood that the coolant CL will adhere to the beam emitting unit 32 and the detection unit 38 can be reduced.

The pressurization unit 57 can raise pressure in a space within the cover 51 that accommodates the beam emitting unit 32 and the detection unit 38. The pressurization unit 57 is specifically a compressor. The pressurization unit 57 maintains the pressure in the space within the cover 51 with the opening 53 closed at a higher level than pressure around the cover 51 by compressing outside air and supplying the compressed air to the inside of the cover 51.

With this configuration, the likelihood that droplets of the coolant CL will intrude into the space within the cover 51 through a gap around the lid portion 52 to become adhered to the beam emitting unit 32 and the detection unit 38 can be reduced, even when there are minute droplets of the coolant CL about around the composite grinding machine 1.

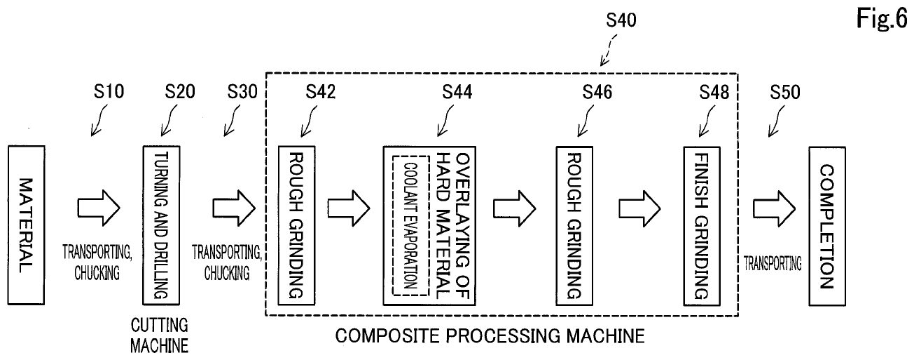

FIG. 6 is a flowchart showing processing for machining of the workpiece WP. First, the workpiece WP that is cylindrical before processing is prepared as a material that is an object of being subjected to processing (see right part of FIG. 6). Note that in the present specification, both the object before being subjected to the processing in FIG. 6 and the object after being subjected to the processing in FIG. 6 are referred to as workpiece WP.

In step S10, the workpiece WP is transported to a cutting machine that is different from the composite grinding machine 1, and attached to a chuck of the cutting machine.

In step S20, machining of turning and drilling is performed on the workpiece WP using the cutting machine. In step S30, the workpiece WP is removed from the cutting machine. The workpiece WP is then transported to the composite grinding machine 1 according to the first embodiment, and attached to the headstock 13 of the composite grinding machine 1 (see lower part of FIG. 1).

In step S40, additive manufacturing, and grinding that is removal machining, are performed on the workpiece WP using the composite grinding machine 1. Step S40 includes steps S42, S44, S46, and S48. The workpiece WP is continuously held by the headstock 13 and the tailstock 14 without being removed from the headstock 13 and the tailstock 14 while the steps S42, S44, S46, and S48 are performed.

In step S42, rough grinding is performed on the workpiece WP. More specifically, rough grinding is performed on the workpiece WP that is being rotated by the holding unit 100, by the grinding unit 200 bringing the grinding wheel 21 into contact with the workpiece WP while rotating the grinding wheel 21. The coolant supply unit 400 supplies the coolant CL to the portion CP at which the workpiece WP held by the holding unit 100 and the grinding wheel 21 come into contact with each other. At this time, the grinding wheel 21 for the rough grinding in step S42 is attached to the grinding unit 200. The lid portion 52 of the protective unit 500 is situated at the closed position Pc (see middle part of FIG. 4). The beam emitting unit 32 and the detection unit 38 are covered by the cover 51 of the protective unit 500. A functional unit of the CPU 940 that realizes the processing of performing rough grinding by controlling each of the parts in step S42 is illustrated as a first rough grinding unit 942 in FIG. 1.

After the completion of rough grinding, the grinding unit 200 is moved to a position farther from the rotational axis of the headstock 13 than in the state in FIG. 4 (see Az2 in FIG. 5). The lid portion 52 of the protective unit 500 is situated at the open position Po (see middle part of FIG. 5). The additive manufacturing unit 300 is then moved to a position closer to the rotational axis of the headstock 13 than in the state in FIG. 4, through the opening of the cover 51, under control of the control unit 900 (see Az3 in FIG. 5).

Thereafter, the grinding wheel for rough grinding in step S42 that is attached to the grinding unit 200 is replaced with a grinding wheel for rough grinding in step S46.

In step S44, overlay processing of a hard material is performed. More specifically, the additive layer Md of cemented carbide is formed on the surface Sw of the workpiece WP by the additive manufacturing unit 300 (see FIG. 2). In the overlay processing of the hard material, the control unit 900 first detects coolant CL adhering to the surface Sw of the workpiece WP by the detection unit 38. The control unit 900 then controls the output of the light beam LB for when causing adhesion of the material Mx to the surface Sw, based on detection results by the detection unit 38.

By performing such processing, the output of the light beam LB can be increased taking into consideration the effects of the coolant CL, when there is residual coolant CL on the surface Sw of the workpiece WP produced by the additive manufacturing unit 300. Accordingly, the likelihood that precision of adhesion of the material Mx to the surface Sw by the additive manufacturing unit 300 will deteriorate, due to the coolant CL adhering to the workpiece WP, can be reduced. A functional unit of the CPU 940 that realizing the processing of performing overlay processing by controlling each of the parts in step S44 is illustrated as an overlaying unit 944 in FIG. 1.

After the additive manufacturing processing, the additive manufacturing unit 300 moves to inside of the cover 51, under the control of the control unit 900 (see Az3 in FIG. 4). Thereafter, the lid portion 52 of the protective unit 500 is situated at the closed position Pc (see middle part of FIG. 4). When the lid portion 52 is situated at the closed position Pc, the opening 53 of the cover 51 is closed by the lid portion 52. The grinding unit 200 is moved to a position closer to the rotational axis of the headstock 13 than in the state in FIG. 5 (see Az2 in FIG. 4).

In step S46, rough grinding is performed on the workpiece WP. More specifically, the grinding unit 200 performs rough grinding on the additive layer Md formed on the workpiece WP by bringing the grinding wheel 21 into contact with the workpiece WP that is being rotated by the holding unit 100, while rotating the grinding wheel 21. The coolant supply unit 400 supplies the coolant CL to the portion CP at which the workpiece WP held by the holding unit 100 and the grinding wheel 21 come into contact with each other. As a result, the peaks formed on the surface of the additive layer Md are roughly removed. At this time, the grinding wheel 21 for rough grinding in step S46 is attached to the grinding unit 200. The lid portion 52 of the protective unit 500 is situated at the closed position Pc (see middle part of FIG. 4). The beam emitting unit 32 and the detection unit 38 are covered by the cover 51 of the protective unit 500 (see FIG. 4). A functional unit of the CPU 940 that realizes the processing of performing rough grinding by controlling each of the parts in step S46 is illustrated as a second rough grinding unit 946 in FIG. 1.

After the completion of rough grinding, the grinding unit 200 is moved to a position farther from the rotational axis of the headstock 13 than in the state in FIG. 4 (see Az2 in FIG. 5). The grinding wheel for rough grinding in step S46 that is attached to the grinding unit 200 is replaced with a grinding wheel for finish grinding in step S48. Thereafter, the grinding unit 200 is moved to a position closer to the rotational axis of the headstock 13 than in the state in FIG. 5 (see Az2 in FIG. 4).

In step S48, finish grinding is performed on the workpiece WP. More specifically, the grinding unit 200 performs finish grinding on the additive layer Md formed on the workpiece WP by bringing the grinding wheel 21 into contact with the workpiece WP being rotated by the holding unit 100, while rotating the grinding wheel 21. The coolant supply unit 400 supplies the coolant CL to the portion CP at which the workpiece WP held by the holding unit 100 and the grinding wheel 21 come into contact with each other. As a result, the surface of the additive layer Md is machined flat. At this time, the grinding wheel 21 for finish grinding in step S48 is attached to the grinding unit 200. The lid portion 52 of the protective unit 500 is situated at the closed position Pc (see middle part of FIG. 4). The beam emitting unit 32 and the detection unit 38 are covered by the cover 51 of the protective unit 500 (see FIG. 4). A functional unit of the CPU 940 that realizes the processing of performing finish grinding by controlling each of the parts in step S48 is illustrated as a finish grinding unit 948 in FIG. 1.

After the completion of finish grinding, the grinding unit 200 is moved to a position farther from the rotational axis of the headstock 13 than in the state in FIG. 4 (see Az2 in FIG. 5).

In step S50, the workpiece WP is removed from the headstock 13 of the composite grinding machine 1 (see the lower part of FIG. 1), and transported to a predetermined finished product storage site. Processing of machining the workpiece WP is completed through the above processing.

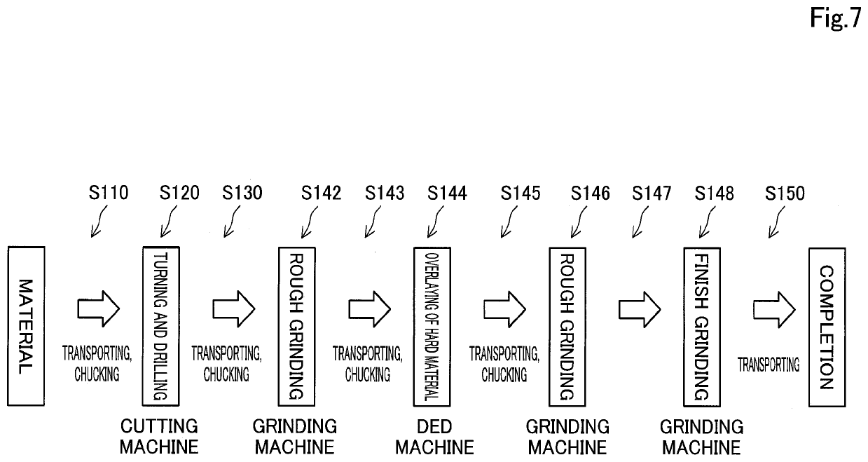

FIG. 7 is a flowchart showing conventional processing of machining the workpiece WP. In the conventional processing for machining the workpiece WP, the processing from preparing the material that is the object to be processed to step S120 is the same as the processing from preparing the material that is the object to be processed to S20 in FIG. 6 according to the present embodiment.

In step S130, the workpiece WP is removed from the cutting machine. The workpiece WP is then transported to a conventional grinding machine, and attached to a headstock of the grinding machine.

In step S142, rough grinding is performed on the workpiece WP by the grinding machine. At this time, the grinding wheel 21 for rough grinding in step S142 is attached to the grinding machine.

After rough grinding, the grinding wheel for rough grinding in step S142 that is attached to the grinding machine is replaced with a grinding wheel for rough grinding in step S146.

In step S143, the workpiece WP is removed from the grinding machine. The workpiece WP is then transported to a DED processing machine, and the workpiece WP is attached to the DED processing machine.

In step S144, overlay processing of a hard material is performed. More specifically, the additive layer Md of cemented carbide is formed on the surface Sw of the workpiece WP by the DED processing machine (see FIG. 2).

In step S145, the workpiece WP is removed from the DED processing machine. The workpiece WP is then transported to the conventional grinding machine, and the workpiece WP is attached to the headstock of the grinding machine (see lower part of FIG. 1).

In step S146, rough grinding is performed on the workpiece WP. At this time, the grinding wheel 21 for rough grinding in step S146 is attached to the grinding machine.

In step S147, the grinding wheel for rough grinding in step S146 that is attached to the grinding machine is replaced with a grinding wheel for finish grinding in step S148.

In step S148, finish grinding is performed on the workpiece WP. At this time, the grinding wheel 21 for finish grinding in step S48 is attached to the grinding unit 200.

In step S150, the workpiece WP is removed from the headstock of the grinding machine, and transported to a predetermined finished product storage site. Conventional processing of machining the workpiece WP is completed through the above processing.

In the conventional processing, the workpiece WP is sequentially attached to the grinding machine, the DED processing machine, and the grinding machine while steps S142 to S148 are performed. In the attachment to the grinding machine the first time, attachment to the DED processing machine, and the attachment to the grinding machine the second time, the respective positions of attachment of the workpiece WP to the processing machines, and consequently the respective centers of rotation of the workpiece WP on the processing machines are mutually misaligned. Thus, it is necessary to set the so-called machining allowance to be great in the processing performed on the workpiece WP using the conventional grinding machine and DED processing machine.

Conversely, in steps S42, S44, S46, and S48 according to the present embodiment, the additive manufacturing, and the grinding that is removal machining, are performed on the workpiece WP using the composite grinding machine 1 (see S40 in FIG. 6). Accordingly, during this time, detachment and attachment of the workpiece WP from and to the composite grinding machine 1 are not performed. Thus, the so-called machining allowance can be set to be small. Also, with the composite grinding machine 1, neither transporting of the workpiece WP between machining devices, nor setup work at each machining device, is necessary. Therefore, the time required to machine the workpiece WP can be reduced, as compared to the processing shown in FIG. 7. As a result, the cost of machining the workpiece WP can also be reduced.

In the present embodiment, additive manufacturing, and grinding that is removal machining, are performed by a single composite grinding machine 1 (see S40 in FIG. 6). Accordingly, in comparison with the form in FIG. 7 that uses the grinding machine and the DED processing machine, space required for such processing in a factory can be reduced.

In a form in which the workpiece WP is plated instead of performing DED, hexavalent chromium is used. However, in the present embodiment, the additive layer Md is formed on the surface Sw of the workpiece WP by DED instead of plating. Accordingly, treating by and managing of hexavalent chromium is unnecessary.

The grinding wheel 21 in the present embodiment is also referred to as a “grindstone”. The beam emitting unit 32 is also referred to as “optical equipment”.

### B. Second Embodiment

In a composite grinding machine 2 according to a second embodiment, a layout of a grinding unit 202, an additive manufacturing unit 302, and a configuration of a protective unit 502, are each different from the layout of the grinding unit 200 and the additive manufacturing unit 300, and the configuration of the protective unit 500, of the composite grinding machine 1 according to the first embodiment. Also, in the second embodiment, configurations of part of surfaces of the beam emitting unit 32 and the material supply unit 33 differ from those of the beam emitting unit 32 and the material supply unit 33 according to the first embodiment. Other points of the composite grinding machine 2 according to the second embodiment are the same as those of the composite grinding machine 1 according to the first embodiment.

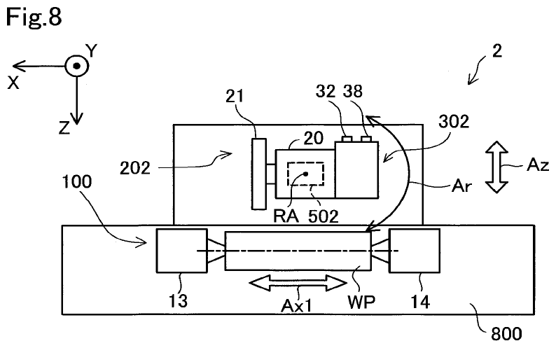

FIG. 8 is an explanatory diagram illustrating a layout of the grinding unit 202, the additive manufacturing unit 302, and the protective unit 502. FIG. 8 corresponds to FIG. 3. FIG. 8 to FIG. 10 correspond to plan views. Note that, however, FIG. 8 to FIG. 10 do not accurately represent the dimensions and shapes of the configurations of each of the parts. Also, in FIG. 8 to FIG. 10, part of the configurations of the composite grinding machine 2 are omitted from illustration, in order to facilitate understanding of the technology.

The grinding unit 202 has configurations corresponding to the configurations of the grinding unit 200 of the composite grinding machine 1 according to the first embodiment, and has the same functions as the grinding unit 200. In FIG. 8, components having the same functions as the configurations illustrated in FIG. 3 are denoted by the same signs.

A liquid supply unit that is omitted from illustration has the same configuration as the coolant supply unit 400 of the composite grinding machine 1 according to the first embodiment. The liquid supply unit is fixed with respect to the grinding unit 202.

The additive manufacturing unit 302 has configurations corresponding to the configurations of the additive manufacturing unit 300 of the composite grinding machine 1 according to the first embodiment, and has the same functions as the additive manufacturing unit 300. In FIG. 8, the beam emitting unit 32 faces in the Z-axial negative direction. In the second embodiment, the grinding unit 202 and the additive manufacturing unit 302 are configured integrally.

In the second embodiment, outer surfaces of the beam emitting unit 32 and the detection unit 38 are provided with structures that repel the coolant CL. Specifically, an outer surface of a window portion 32w through which the light beam LB passes in the beam emitting unit 32 is coated with polytetrafluoroethylene (PTFE) (see FIG. 2). In the detection unit 38, an outer surface of a window portion through which external light taken into the detection unit 38 passes is coated with PTFE. As a result, the coolant CL is prevented from adhering to the outer surfaces of the window portions of the beam emitting unit 32 and the detection unit 38.

According to such a configuration, the likelihood that the coolant CL will adhere to the beam emitting unit 32 and the detection unit 38 can be reduced without adding a large-scale configuration to the composite grinding machine 1. Accordingly, the degree of freedom in the layout of components such as the grinding wheel 21 for when grinding, and the degree of freedom in the layout of the additive manufacturing unit 302 for when causing adhesion of the material Mx to the surface Sw, can be improved (see Az, Ax1 in FIG. 8).

The protective unit 502 supports the grinding unit 202, the additive manufacturing unit 302, and the liquid supply unit. The protective unit 502 includes a rotational shaft that supports the grinding unit 202, the additive manufacturing unit 302, and the liquid supply unit, and a motor that rotates the rotating shaft. The protective unit 502 can dispose the grinding unit 202, the additive manufacturing unit 302, and the liquid supply unit, in two orientations that are 180° different from each other, about an axis that is parallel to the Y-axial direction. The rotation of the grinding unit 202, the additive manufacturing unit 302, and the liquid supply unit is indicated by an arrow Ar in FIG. 8. The center of rotation is indicated by RA. Further, the protective unit 502 can move the grinding unit 202, the additive manufacturing unit 302, and the liquid supply unit, along the Z-axial direction, to a position closer to the rotational axis of the headstock 13 than in the state illustrated in FIG. 8. In FIG. 8 to FIG. 10, movement of the grinding unit 202 and the additive manufacturing unit 302 in the Z-axial direction is indicated by an arrow Az.

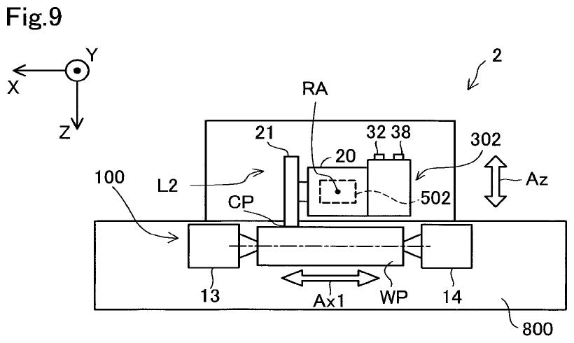

FIG. 9 is an explanatory diagram illustrating a state of the protective unit 502 and the additive manufacturing unit 302 at a time of the workpiece WP being ground by the grinding wheel 21 of the grinding unit 202 while held by the holding unit 100. FIG. 9 corresponds to FIG. 4. When the workpiece WP that is held by the holding unit 100 is ground by the grinding wheel 21 of the grinding unit 202, the grinding unit 202 is moved to a position closer to the rotational axis of the headstock 13 than in the state in FIG. 8 (see Az in FIG. 9).

When the workpiece WP held by the holding unit 100 is ground by the grinding wheel 21 of the grinding unit 202, the beam emitting unit 32 and the detection unit 38 are disposed on a side opposite from the portion CP where the workpiece WP and the grinding wheel 21 come into contact, with respect to the wheel spindle stock 20 (see upper right part of FIG. 9).

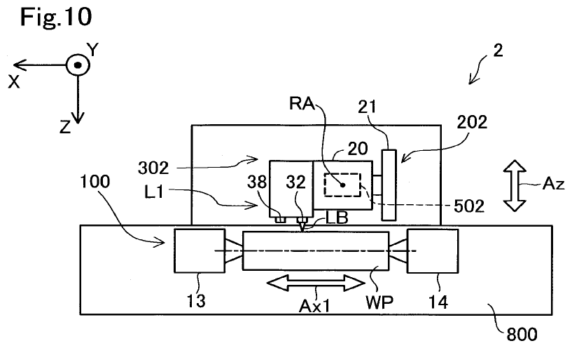

FIG. 10 is an explanatory diagram illustrating a state of the protective unit 502 and the additive manufacturing unit 302 at a time of the additive manufacturing unit 302 causing adhesion of the material Mx to the surface Sw of the workpiece WP. FIG. 10 corresponds to FIG. 5. The layout of the additive manufacturing unit 302 including the beam emitting unit 32, the grinding unit 202, and the liquid supply unit, illustrated in FIG. 10, will be referred to as “first equipment layout L1.” In contrast, the layout of the additive manufacturing unit 302 including the beam emitting unit 32, the grinding unit 202, and the liquid supply unit, illustrated in FIG. 9, will be referred to as “second equipment layout L2”.

When the additive manufacturing unit 300 causes adhesion of the material Mx to the surface Sw of the workpiece WP, the protective unit 502 arranges the grinding unit 202, the additive manufacturing unit 302, and the liquid supply unit, in an orientation 180° different from the orientation illustrated in FIG. 9. In FIG. 10, the beam emitting unit 32 faces in the Z-axial positive direction. At this attitude, the beam emitting unit 32 can emit the light beam LB to the surface Sw of the workpiece WP. The detection unit 38 can acquire the state of the workpiece WP. As a result, the additive manufacturing unit 302 can cause adhesion of the material Mx to the surface Sw of the workpiece WP (see FIG. 2). Note that at this attitude, the grinding wheel 21 of the grinding unit 202 is located further from the rotational axis of the headstock 13 than in the state illustrated in FIG. 9 (see middle right part of FIG. 10).

According to such a configuration, the likelihood of adhesion of the coolant CL to the beam emitting unit 32 can be reduced, without disposing a structure such as the lid portion 52 between the portion CP where the workpiece WP and the grinding wheel 21 come into contact, and the beam emitting unit 32 (see FIG. 4 and FIG. 9). Thus, the number of configurations disposed on the bed 800 can be reduced as compared to a form including configurations such as the cover 51 and the lid portion 52. As a result, a large space can be secured on the bed 800, over which the grinding wheel 21 and the beam emitting unit 32 can be moved. Thus, the degree of freedom in the layout of components such as the grinding wheel 21 for when grinding, and the degree of freedom in the layout of components such as the beam emitting unit 32 for when performing additive manufacturing, can be increased (see Az, Ax1 in FIG. 8).

### C. Third Embodiment

In a composite grinding machine 3 according to a third embodiment, a layout of a grinding unit 203, an additive manufacturing unit 303, and a configuration of a protective unit 503, are each different from the layout of the grinding unit 200 and the additive manufacturing unit 300, and the configuration of the protective unit 500, of the composite grinding machine 1 according to the first embodiment. Also, with the composite grinding machine 3 according to the third embodiment, in step S44 of FIG. 6, processing of evaporating the coolant is performed prior to the processing of overlaying with the hard material. Other points of the composite grinding machine 3 according to the third embodiment are the same as the composite grinding machine 1 according to the first embodiment.

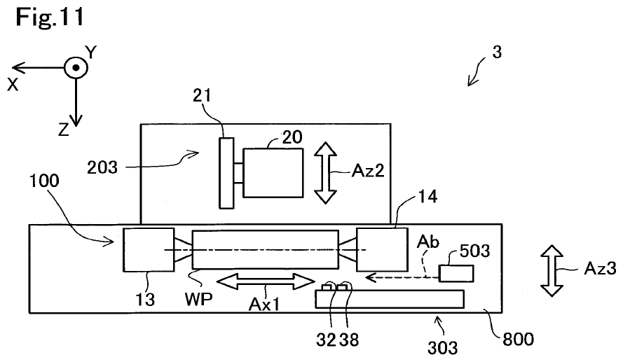

FIG. 11 is an explanatory diagram illustrating a layout of the grinding unit 203, the additive manufacturing unit 303, and the protective unit 503. FIG. 11 corresponds to FIG. 3. FIG. 11 to FIG. 13 correspond to plan views. Note that, however, FIG. 11 to FIG. 13 do not accurately represent the dimensions and shapes of the configurations of each of the parts. Also, in FIG. 11 to FIG. 13, part of the configurations of the composite grinding machine 3 are omitted from illustration, in order to facilitate understanding of the technology.

The grinding unit 203 has configurations corresponding to the configurations of the grinding unit 200 of the composite grinding machine 1 according to the first embodiment, and has the same functions as the grinding unit 200. In FIG. 11, configurations having the same functions as those illustrated in FIG. 3 are denoted by the same signs.

A liquid supply unit that is omitted from illustration has the same configuration as the coolant supply unit 400 of the composite grinding machine 1 according to the first embodiment. The liquid supply unit is fixed with respect to the grinding unit 203.

The additive manufacturing unit 303 has configurations corresponding to the configurations of the additive manufacturing unit 300 of the composite grinding machine 1 according to the first embodiment, and has the same functions as the additive manufacturing unit 300. In the third embodiment, the additive manufacturing unit 303 is disposed on the opposite side of the workpiece WP held by the holding unit 100 from the portion CP where the workpiece WP and the grinding wheel 21 come into contact.

The protective unit 503 is an air curtain. The protective unit 503 can generate an air flow Ab between the portion CP where the workpiece WP held by the holding unit 100 and the grinding wheel 21 come into contact, and the beam emitting unit 32. More specifically, the protective unit 503 causes the air flow Ab between the side of the workpiece WP held by the holding unit 100 that is opposite to the portion CP, and the beam emitting unit 32. The air flow Ab generated by the protective unit 503 has a direction from the protective unit 503 toward the X-axial positive direction. The air flow Ab generated by the protective unit 503 is discharged into a range that includes the range occupied by the beam emitting unit 32 with respect to the Y-axial direction.

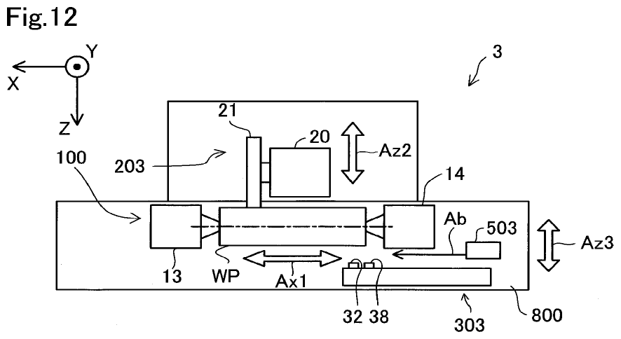

FIG. 12 is an explanatory diagram illustrating a state of the protective unit 503 and the additive manufacturing unit 303 at a time of the workpiece WP being ground by the grinding wheel 21 of the grinding unit 203 while held by the holding unit 100. FIG. 12 corresponds to FIG. 4. When the workpiece WP that is held by the holding unit 100 is ground by the grinding wheel 21 of the grinding unit 203, the grinding unit 203 is moved to a position closer to the rotational axis of the headstock 13 than in the state in FIG. 11 (see Az2 in FIG. 12).

When the workpiece WP held by the holding unit 100 is ground by the grinding wheel 21 of the grinding unit 203, the protective unit 503 generates the air flow Ab between the portion CP where the workpiece WP and the grinding wheel 21 come into contact, and the beam emitting unit 32.

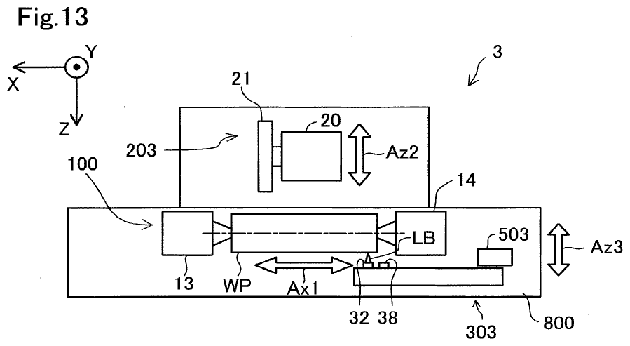

FIG. 13 is an explanatory diagram illustrating a state of the protective unit 503 and the additive manufacturing unit 303 at a time of the additive manufacturing unit 303 causing adhesion of the material Mx to the surface Sw of the workpiece WP. FIG. 13 corresponds to FIG. 5.

When the additive manufacturing unit 303 causes adhesion of the material Mx to the surface Sw of the workpiece WP, the additive manufacturing unit 303 is moved to a position closer to the rotational axis of the headstock 13 than in the state in FIG. 12 (see Az3 in FIG. 13). In this state, the additive manufacturing unit 303 can cause adhesion of the material Mx to the surface Sw of the workpiece WP (see FIG. 2). Note that at this time, the grinding unit 203 is moved to a position farther from the rotational axis of the headstock 13 than in the state in FIG. 12 (see Az2 in FIG. 13).

According to such a configuration, the likelihood of adhesion of the coolant CL to the beam emitting unit 32 can be reduced, without disposing a dedicated structure for shielding from the coolant CL between the portion CP where the workpiece WP and the grinding wheel 21 come into contact, and the beam emitting unit 32 (see FIG. 4 and FIG. 12). Accordingly, a large space can be secured on the bed 800, over which the grinding wheel 21 and the beam emitting unit 32 can be moved. Thus, the degree of freedom in the layout of components such as the grinding wheel 21 for when grinding, and the degree of freedom in the layout of components such as the beam emitting unit 32 for when performing additive manufacturing, can be increased (see Ax1, Az2, Az3 in FIG. 11).

With the composite grinding machine 3 according to the third embodiment, in step S44 of FIG. 6, processing of evaporating the coolant is performed prior to the processing of overlaying the hard material. Specifically, the control unit 900 causes the holding unit 100 to rotate the workpiece WP and also performs moving thereof in the X-axial direction, and during that time, the detection unit 38 detects coolant CL adhering to the surface Sw of the workpiece WP. When the control unit 900 detects the coolant CL, the control unit 900 controls the beam emitting unit 32 to emit the light beam LB to the coolant CL adhering to the workpiece WP, thereby evaporating the coolant CL. The processing of controlling each part to evaporate the coolant CL in step S44 is shown surrounded by dashed lines in FIG. 6. A functional unit of the CPU 940 that realizes the processing of performing evaporation of the coolant CL by controlling each of the parts in step S44 is illustrated as an evaporation unit 944b in FIG. 1.

By performing such processing, the coolant CL adhering to the workpiece WP can be evaporated and removed prior to the adhesion of the material Mx to the surface Sw of the workpiece WP by the additive manufacturing unit 303 (see S44 in FIG. 6). Accordingly, the likelihood that the precision of adhesion of the material Mx to the surface Sw of the workpiece WP by the additive manufacturing unit 303 will deteriorate, due to the coolant CL adhering to the workpiece WP, can be reduced.

### D. Other Embodiments

### D1. Other Embodiment 1:

(1) In the embodiments described above, the material supply unit 33 supplies the powder Mf of cemented carbide to the outside of the additive manufacturing unit 300. However, a variety of materials may be employed as the material of the additive layer Md, such as an Fe-based alloy, a Ni-based alloy, a Co-based alloy, a Cu-based alloy, an Al-based alloy, ceramics, and so forth. These alloys may be alloys to which chromium, cobalt, vanadium, or the like, is added.

Also, a variety of materials such as carbon steel, bearing steel, stainless steel, aluminum, and so forth, can be employed as the material of the workpiece.
(2) In the embodiments described above, the material supply unit 33 supplies the powder Mf of cemented carbide to the outside of the additive manufacturing unit 300. However, the material supply unit may supply the material in a form of a wire. Alternatively, the material supplied by the material supply unit may be high-speed steel, rather than cemented carbide.
(3) In the embodiments described above, the grinding unit 200 and the additive manufacturing unit 300 are moved in the Z-axial direction, and the holding unit 100 is moved in the X-axial direction. However, one of the grinding unit and the holding unit may be configured to be movable in two directions that are perpendicular to each other. That is to say, it is sufficient for the composite grinding machine to be configured such that the grinding unit can assume any position within a plane relative to the holding unit. Also, one of the additive manufacturing unit and the holding unit may be configured to be movable in two directions that are perpendicular to each other. That is to say, it is sufficient for the composite grinding machine to be configured such that the additive manufacturing unit can assume any position within a plane relative to the holding unit.
(4) In the first embodiment described above, the cover 51 covers the entirety of the beam emitting unit 32 and the detection unit 38. However, the cover may be configured not to cover part of the optical equipment, such as a portion of the beam emitting unit 32 on the opposite side of the portion at which the window portion 32w for passage of the light beam LB is provided, or a portion on the opposite side of the portion at which the window portion for passage of external light taken into the detection unit 38 is provided, or the like, for example.
(5) In the first embodiment described above, when the workpiece WP that is held by the holding unit 100 is ground by the grinding wheel 21 of the grinding unit 200, the lid portion 52 is situated at the closed position Pc (see middle part of FIG. 4). However, the lid portion 52 can also be situated in the closed position Pc while other processing that is not non-manufacturable is being performed, such as during processing of evaporating the coolant, for example (see S44 in FIG. 6).
(6) In the embodiment described above, the detection unit 38 is an infrared camera. However, the detection unit may include a different configuration, such as a digital still camera that records visible light, a camera that can record moving images, or the like. It is sufficient for the detection unit to be able to detect coolant adhering to the surface of the workpiece.
(7) In the second embodiment described above, the protective unit 502 can dispose the grinding unit 202, the additive manufacturing unit 302, and the liquid supply unit, in two orientations that are 180° different from each other, about an axis that is parallel to the Y-axial direction. However, the two equipment arrangements that the grinding unit and the additive manufacturing unit are capable of assuming may be arrangements having two different orientations, such as 90° and 120°, which are smaller than 180° with respect to each other. Furthermore, the two device arrangements can be realized by any combination of rotation, linear movement, and curved movement of the equipment.
(8) In the second embodiment described above, the outer surface of the window portion 32w through which the light beam LB passes in the beam emitting unit 32 is coated with PTFE (see FIG. 2). In the detection unit 38, an outer surface of a window portion through which external light taken into the detection unit 38 passes is coated with PTFE. However, coolant-repellent structures are not limited to the addition of chemicals such as PTFE or the like to the surfaces of components. For example, the coolant-repelling structures may be realized as so-called functional surfaces by texturing surface texture of the components such that coolant does not readily adhere to the surfaces thereof. Also, the performance of the surface of the component, such as water repellency, oil repellency, and so forth, can be decided depending on the coolant used in the composite grinding machine.
(9) In the embodiments described above, the beam emitting unit 32 of the additive manufacturing unit 300 performs emitting of a laser beam. However, the additive manufacturing unit may heat and fuse material by arc plasma, or emitting of an electron beam, instead of a laser beam.

### D2. Other Embodiment 2:

In the embodiments described above, the composite grinding machine 1 includes the beam emitting unit 32 as optical equipment, and the protective unit 500. However, the composite grinding machine may be configured as a form without at least one of the optical equipment and protective unit.

### D3. Other Embodiment 3:

In the first embodiment described above, the cover 51 has the opening 53 and the lid portion 52. However, the cover that covers the optical equipment may have a form including a window portion that enables light to pass from inside of the cover to the outside, and from the outside to the inside, and a removal unit that enables removal of coolant adhering to the window portion. The removal unit may be configured to remove coolant adhering to the window portion by, for example, spraying fluid onto the window portion. For example, the removal unit may be configured to have a function of wiping off coolant adhering to the window portion.

### D4. Other Embodiment 4:

In the first embodiment described above, the protective unit 500 has the pressurization unit 57 (see upper middle part of FIG. 3). However, the protective unit 500 can have a form of having the cover 51 and not having the pressurization unit 57.

### D5. Other Embodiment 5:

In the first embodiment described above, when the workpiece WP held by the holding unit 100 is ground by the grinding wheel 21 of the grinding unit 202, the beam emitting unit 32 and the detection unit 38 are disposed on a side opposite from the portion CP where the workpiece WP and the grinding wheel 21 come into contact, with respect to the wheel spindle stock 20 (see upper right part of FIG. 9). However, a form may be made in which, when the workpiece is being ground by the grindstone of the grinding unit, the optical equipment is situated at a position farther from the grinding unit than when the additive manufacturing unit causes adhesion of material to the surface of the workpiece.

### D6. Other Embodiment 6:

In the third embodiment described above, the protective unit 503 is an air curtain. However, the protective unit can also be a shield, which is a specific structure that is situated between the optical equipment and the workpiece, and that obstructs movement of the coolant. Such a shield is preferably retracted from between the optical equipment and the workpiece when the additive manufacturing unit causes adhesion of material to the surface of the workpiece.

### D7. Other Embodiment 7:

In the second embodiment described above, the outer surface of the window portion 32w through which the light beam LB passes in the beam emitting unit 32 is coated with PTFE (see FIG. 2). However, a form may be made in which the surface of the optical equipment is not provided with a coolant-repelling structure.

### D8. Other Embodiment 8:

With the composite grinding machine 3 according to the third embodiment described above, in step S44 of FIG. 6, processing of evaporating the coolant is performed prior to the processing of overlaying the hard material. After the processing of evaporating the coolant, some of the coolant may remain on the surface of the workpiece. Also, a form may be made in which the processing of evaporating the coolant is not performed prior to the processing of overlaying the hard material.

### D9. Other Embodiment 9:

In the overlaying processing of the hard material according to the first embodiment described above, the control unit 900 first detects coolant CL adhering to the surface Sw of the workpiece WP by the detection unit 38. The control unit 900 then controls the output of the light beam LB for when causing adhesion of the material Mx to the surface Sw, based on detection results by the detection unit 38. However, an arrangement may be made in which such processing is not performed, and for example, the output of the light beam LB may be controlled to be constant.

The present disclosure is not limited to the embodiment discussed above, and can be implemented with a variety of configurations without departing from the essence thereof. For example, the technical features of the embodiment corresponding to the technical features in each aspect described in the SUMMARY OF THE INVENTION can be replaced or combined, as appropriate, in order to solve some or all of the issues described above or achieve some or all of the effects described above. Also, technical features can be deleted, as appropriate, unless such technical features are described as essential in the present specification.

### DESCRIPTION OF THE REFERENCE NUMERALS

1 Composite grinding machine
2 Composite grinding machine
3 Composite grinding machine
12 Table
13 Headstock
14 Tailstock
15 Chuck
16 Center
20 Wheel spindle stock
21 Grindstone wheel
21a Cylindrical grinding face
22 Grindstone drive motor
23 Grindstone spindle
24 Belt transmission mechanism
32 Beam emitting unit
33 Material supply unit
34 Oscillating unit
35 Optical system
32w Window portion
38 Detection unit
40 Control unit
51 Cover
52 Lid portion
53 Opening
57 Pressurization unit
100 Holding unit
200 Grinding unit
202 Grinding unit
203 Grinding unit
300 Additive manufacturing unit
302 Additive manufacturing unit
303 Additive manufacturing unit
400 Coolant supply unit
500 Protective unit
502 Protective unit
503 Protective unit
800 Bed
900 Control unit
942a First rough grinding unit
944 Overlaying unit
944b Evaporation unit
946 Second rough grinding unit
948 Finish grinding unit
950 RAM
960 ROM
970 Display
980 Keyboard
Ab Air flow
Ar Arrow indicating rotational operation of grinding unit 202 and additive manufacturing unit 302
Ax1 Arrow indicating movement of holding unit 100
Az Arrow indicating movement of grinding unit 202 and additive manufacturing unit 302
Az2 Arrow indicating movement of grinding unit 200
Az3 Arrow indicating movement of additive manufacturing unit 300
CL Coolant
CP Portion at which workpiece WP and grinding wheel 21 come into contact with each other
L1 First equipment layout
L2 Second equipment layout
LB Light beam
Md Additive layer
Mf Powder material
Mx Material
Pc Closed position of lid unit 52
Po Open position of lid unit 52
RA Center of rotation of grinding unit 202 and additive manufacturing unit 302
Sw Surface of workpiece WP
WP Workpiece

1. A composite grinding machine, comprising:
a holding unit that is configured to hold and rotate a workpiece;
an additive manufacturing unit that is configured to move with respect to the holding unit, and that fuses a material while supplying the material to a surface of the workpiece that is held by the holding unit, thereby causing adhesion of the material to the surface;
a grinding unit that is configured to move with respect to the holding unit, and that includes a grindstone and rotates the grindstone; and
a coolant supply unit that supplies a coolant to a portion where the workpiece held by the holding unit and the grindstone come into contact.

2. The composite grinding machine according to claim 1, wherein:
the additive manufacturing unit includes optical equipment used for adhesion of the material to the surface; and
the composite grinding machine further comprises a protective unit that prevents the coolant from adhering to the optical equipment.

3. The composite grinding machine according to claim 2, wherein:
the protective unit includes a cover that has an opening and a lid portion configured to open and close the opening, and that covers the optical equipment; and
the protective unit is configured to selectively place the lid portion in an open position in which the lid portion opens the opening, and the optical equipment takes in light or emits light through the opening when the additive manufacturing unit causes adhesion of the material on the surface, and in a closed position in which the lid portion closes the opening.

4. The composite grinding machine according to claim 3, wherein the protective unit further includes a pressurization unit configured to increase pressure of space within the cover that accommodates the optical equipment.

5. The composite grinding machine according to claim 2, wherein the protective unit is configured to selectively place the optical equipment in a first equipment layout in which the optical equipment is situated when the additive manufacturing unit causes adhesion of the material to the surface, and in a second equipment layout in which the optical equipment is situated when the workpiece held by the holding unit is being ground by the grindstone, and in which the optical equipment is situated, with respect to a component that is not the optical equipment out of components of the composite grinding machine, on a side opposite from the portion where the workpiece and the grindstone come into contact.

6. The composite grinding machine according to claim 2, wherein the protective unit is an air curtain configured to create an air flow between the portion where the workpiece and the grindstone come into contact, and the optical equipment.

7. The composite grinding machine according to claim 2, wherein the protective unit is provided on a surface of the optical equipment and is of a structure that repels the coolant.

8. The composite grinding machine according to any one of claims 2 to 7, wherein:
the additive manufacturing unit includes, as the optical equipment, a beam emitting unit that emits a light beam that fuses the material; and
the composite grinding machine further comprises a control unit that controls the composite grinding machine, and that controls the beam emitting unit to emit the light beam to the coolant adhered to the workpiece prior to causing adhesion of the material to the surface, such that at least part of the coolant adhered to the workpiece evaporates.

9. The composite grinding machine according to any one of claims 2 to 7, wherein:
the additive manufacturing unit includes, as the optical equipment, a beam emitting unit that emits a light beam that fuses the material; and
the composite grinding machine further comprises
a detection unit that is configured to detect the coolant adhered to the surface, and
a control unit that controls output of the light beam for when causing adhesion of the material to the surface, based on a detection result by the detection unit.
